(19) United States
(12) Patent Application Publication
(10) Pub. No.: US 2013/0043427 A1
(43) Pub. Date: Feb. 21, 2013

(54) NOVOLAC-BASED C-SN MATERIALS, PRODUCTION THEREOF AND USE THEREOF IN ELECTROCHEMICAL CELLS

(71) Applicants: Gerhard COX, Bad Duerkheim (DE); Klaus LEITNER, Ludwigshafen (DE); Arno LANGE, Bad Duerkheim (DE); Ruediger OESTEN, Frankenthal (DE); Markus HÖLZLE, Kirchheim (DE)

(72) Inventors: Gerhard COX, Bad Duerkheim (DE); Klaus LEITNER, Ludwigshafen (DE); Arno LANGE, Bad Duerkheim (DE); Ruediger OESTEN, Frankenthal (DE); Markus HÖLZLE, Kirchheim (DE)

(73) Assignee: BASF SE, Ludwigshafen (DE)

(21) Appl. No.: 13/587,055

(22) Filed: Aug. 16, 2012

Related U.S. Application Data
(60) Provisional application No. 61/525,236, filed on Aug. 19, 2011.

(51) Int. Cl. C08G 8/28; H01M 4/48

(52) U.S. Cl. 252/182.1; 525/506

(57) ABSTRACT

The present invention relates to a process for producing an Sn(II)-crosslinked novolac material, to the Sn(II)-crosslinked novolac material obtainable by the process according to the invention, to a process for producing an electroactive material comprising a carbon phase C and a tin phase and/or tin oxide phase, comprising the process for producing an Sn(II)-crosslinked novolac material and a subsequent carbonization step, to the electroactive material obtainable by the process according to the invention, and to electrochemical cells and batteries comprising the electroactive material.

The present invention relates to a process for producing an Sn(II)-crosslinked novolac material, to the Sn(II)-crosslinked novolac material obtainable by the process according to the invention, to a process for producing an electroactive material comprising a carbon phase C and a tin phase and/or tin oxide phase, comprising the process for producing an Sn(II)-crosslinked novolac material and a subsequent carbonization step, to the electroactive material obtainable by the process according to the invention, and to electrochemical cells and batteries comprising the electroactive material.

Secondary batteries, accumulators or rechargeable batteries are just some embodiments by which electrical energy can be stored after generation and used when required. Due to the significantly better power density, there has been a move in recent times away from the water-based secondary batteries to development of batteries in which the charge transport in the electrical cell is accomplished by lithium ions.

In the lithium ion batteries currently being produced, the cathode typically comprises a lithium-transition metal compound, for example LiCoO₂ or LiFePO₄, and the anode typically comprises graphite into which Li⁰ is intercalated in the charging operation. In order to increase the capacity of the graphite-based anodes, as described in Angew. Chem. 2008, 120, 2972-2989, anodes are being developed which comprise lithium-metal alloys, for example lithium-tin or lithium-silicon alloys. The alloys Li_{4.4}Sn and Li_{4.4}Si can absorb large amounts of lithium and exhibit much higher capacities than a graphite electrode with intercalated Li⁰. Angew. Chem. 2008, 120, 2972-2989 states that “the consequence of accommodating such a large amount of lithium is large volume expansion-contraction that accompanies their electrochemical alloy formation. These changes lead rapidly to deterioration of the electrode (cracks, and eventually, pulverization), thus limiting its lifetime to only a few charge-discharge cycles.”

Angew. Chem. 2008, 120, 2972-2989 discusses the following approach to a solution: “One of the earliest approaches involved replacing bulk material with nanostructured alloys. Reducing the metal particles to nanodimensions does not of course reduce the extent of volume change but does render the phase transitions that accompany alloy formation more facile, and reduces cracking within the electrode. Different synthetic routes have been used to fabricate nanostructured metals that can alloy with lithium, including sol-gel, ball-milling, and electrodeposition. Of these routes, electrodeposition is the most versatile, as it permits easy control of the electrode morphology by varying the synthesis conditions, such as current density and deposition time.”

Preference is given here to electrolytic methods for production of nanoscale Sn-containing anode material for the lithium ion battery.

Angew. Chem. 2009, 121, 1688-1691 proposes the production of SnOₓ/C composites and the conversion thereof to Sn/C materials by CVD (chemical vapor deposition), the purpose of the carbon skeleton being that of stabilization of the Sn particles.

WO 2010/112580 proposes electroactive material which is a co-continuous nanostructured hybrid material and which is obtainable proceeding from a material obtainable by what is called a twin polymerization with a subsequent carbonization step. WO 2010/112580 describes, in the examples, only silicon-containing electroactive materials proceeding from specific soluble spirosilanes. However, it is less simple to produce suitable soluble monomers such as 2,2′-spirobis[4H-1,3,2-benzodioxastannin], since such tin derivatives tend to form highly aggregated, insoluble forms which are difficult to melt, as described, for example, in Cotton-Wilkinson, “Advanced Inorganic Chemistry”, John Wiley & Sons Inc. 6th edition, pages 280, 287 ff.

Sparingly soluble or insoluble starting materials are, however, disadvantageous since, according to WO 2009/083083, the desired specific structures originate from the kinetic coupling in the twin polymerization. Such problems are referred to in Angew. Chem. 2009, 121, 1688-1691, where it is stated that: “The synthesis of nanoparticles and the adjustment of their size can be more difficult.”

CN 101428847 describes the synthesis of a tin-containing nanomaterial for lithium ion batteries, wherein heating of an aqueous solution of tin chloride, resorcinol, hydrochloric acid and formaldehyde, removal of the precipitated hybrid material and calcination under air affords nanostructured tin oxide. A particular disadvantage of this process is the formation, known in the literature, of bis(chloromethyl) ether, which is extremely carcinogenic to humans.

J. Mater. Chem., 2009, 19, 7202-7207 proposes a process for producing core-shell particles as an anode material for the lithium ion battery. In these particles, a Cu₆Sn₅ alloy is the core, carbon the shell. A disadvantage of the process is the complex preparation in 4 separate steps and the fact that carbon and metal are present separately.

It was thus an object of the present invention to find industrially practicable processes by which a nanostructured C/Sn-containing electroactive material suitable as an anode material for lithium ion batteries, especially for lithium ion secondary batteries, and the starting materials therefor, can be produced on the multitonne scale and in reproducible quality. The processes must improve upon the known processes from an economic point of view, for example by avoiding expensive methods such as the CVD process, or else with regard to safety-relevant aspects, such as the avoidance of carcinogenic by-products. It was a further object of the present invention to find novel starting compounds for novel nanostructured C/Sn-containing electroactive materials and the novel electroactive materials producible therefrom, which are easy to produce or are superior to the graphite used to date as an anode material or to alternatives which have been discussed. The electroactive material should have a high specific capacity, a high cycling stability, low self-discharge and/or good mechanical stability.

This object is achieved by a process for producing an Sn(II)-crosslinked novolac material, comprising the process steps of:
(a) reacting at least one novolac comprising aryl units which bear two, three or four hydroxyl groups, with at least two hydroxyl groups adjacent to one another, and which are joined to further aryl units via at least one substituted or unsubstituted alkylene group, with at least one Sn(II) salt, and
(b) optionally isolating the Sn(II)-crosslinked novolac material formed in the form of a powder.

Novolacs and the production thereof have been known to the person skilled in the art for some time and are described in detail, for example, in Houben-Weyl, Methoden der Organischen Chemie [Methods of Organic Chemistry], Thieme Verlag, Stuttgart, volume 14, Part 2: Makromolekulare Stoffe [Macromolecular Substances], pages 193-212, 272-274, and volume E 20, pages 1800-1806. To produce a novolac, phenol or a substituted phenol is condensed with an aldehyde or a ketone, preferably an aldehyde, especially with formaldehyde, under acidic or basic conditions, preferably under acidic conditions, with elimination of water to give linear, uncrosslinked oligomers or polymers. By definition, a novolac molecule is a linear, uncrosslinked unit, which means that the sole aryl unit is bonded to not more than two substituted or unsubstituted alkylene groups.

In the novolac production, the phenol components usable are, for example, phenol, resorcinol, catechol, hydroquinone, pyrogallol, phloroglucinol, apionol, 1,2,4,5-tetrahydroxybenzene, cresols, or else bisphenol A, and the aldehydes or ketones usable are, for example, (para)formaldehyde, trioxane, acetaldehyde, furfural or else acetone.

In the process according to the invention for producing an Sn(II)-crosslinked novolac material, in process step (a), at least one novolac comprising aryl units which bear two, three or four hydroxyl groups, with at least two hydroxyl groups adjacent to one another, and which are joined to further aryl units via at least one substituted or unsubstituted alkylene group, is reacted with at least one Sn(II) salt.

A novolac comprising aryl units which bear two, three or four hydroxyl groups, with at least two hydroxyl groups adjacent to one another, and which are joined to further aryl units via at least one substituted or unsubstituted alkyene group, is known in principle. U.S. Pat. No. 5,859,153 describes, for example, a novolac formed from catechol and formaldehyde.

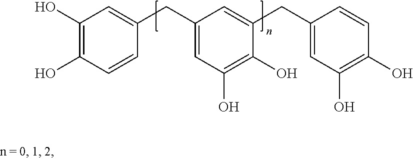

The aryl units which bear two, three or four hydroxyl groups, with at least two hydroxyl groups adjacent to one another, derive from substituted or unsubstituted 1,2-bishydroxybenzene as the phenol component. Examples of such substituted or unsubstituted 1,2-bishydroxybenzenes are 1,2-dihydroxybenzene, 1,2,3-trihydroxybenzene or 1,2,4-trihydroxybenzene. The phenol component used is preferably 1,2-bishydroxybenzene itself, which is also called catechol.

In a specific embodiment, the novolac material may also comprise amine nitrogen. This can be achieved by adding a reactive aminic component (e.g. 4-aminophenol) to the reaction mixture or by allowing the novolac to react further with such a component.

The substituted or unsubstituted alkylene group which joins two aryl units to one another may, for example, be —CH₂—, —CH(Me)-, —CH(1-furyl)- or —C(Me)₂-, preferably —CH₂—. Thus, formaldehyde CH₂O and its equivalents such as paraformaldehyde, aqueous formalin solution or trioxane, also referred to collectively hereinafter as formaldehyde (equivalent) for short, are the preferred components for generation of the preferred alkylene group —CH₂—.

In a preferred embodiment of the process according to the invention, the alkylene groups present in the novolac are methylene units which each join two aryl units to one another. In a further preferred embodiment, the bond formation between the aryl units is accomplished by furfural or mixtures of furfural with formaldehyde (equivalents). Examples are mixtures comprising more than 20 mol % of formaldehyde (equivalent) or better more than 50 mol % of formaldehyde (equivalent) or preferably more than 75 mol % of formaldehyde (equivalent) or more preferably more than 90 mol % of formaldehyde (equivalent).

The further aryl units may either be identical to the aryl units which bear two, three or four hydroxyl groups, with at least two hydroxyl groups adjacent to one another, or derive from any other substituted phenols or phenol itself as the phenol component.

A novolac, such as the example detailed in U.S. Pat. No. 5,859,153 and shown above, consists, like virtually any industrially produced polymer, of polymer chains of different chain lengths, an attempt being made to describe the polymer by stating the average chain length, for example by stating the average number n of monomer units per polymer chain or by stating the weight-average molar mass M_{w}.

The novolac used in the process according to the invention may in principle have any number of aryl units per oligomer or polymer molecule, the lower limit being two, which means that exactly two aryl units are joined to one another via exactly one substituted or unsubstituted alkylene group, especially a methylene unit. The maximum average number of aryl units in the novolac used is preferably up to 1000, more preferably up to 100, even more preferably up to 20, especially up to 10.

Preferably, in process step (a) of the process according to the invention, a novolac having an average of 2 to 10 aryl units, for example 3, 4, 5, 6, 7 or 8 units, is converted.

In a further preferred embodiment of the process according to the invention, in process step (a), a novolac wherein at least 50%, preferably at least 80%, especially at least 95% to at most 100% of the aryl units of the novolac bear two hydroxyl groups which are adjacent, and at least 50%, preferably at least 80%, especially at least 95% to at most 100%, of the alkylene units are methylene groups are converted.

In the process according to the invention, it is possible in principle, in process step (a), to conduct the reaction of the novolac with the Sn(II) salt in any desired manner, provided only that it is ensured that the two components can react with one another. The reaction can accordingly be performed in substance, for example in a melt, or in the presence of a solvent.

In a preferred variant of the process according to the invention, process step (a) is performed in a solvent in which the novolac is present in dissolved form, more preferably in a solvent in which the novolac and the Sn(II) salt are present in dissolved form.

Useful solvents in principle include all solvents in which the novolac used is present in dissolved from. Preferably, in process step (a), the solvent used is water, a C₁-C₆-alkanol, a cyclic or acyclic ether having 4 to 8 carbon atoms or a cyclic or acyclic ketone having 3 to 8 carbon atoms.

Examples of suitable C₁-C₆-alkanols are methanol, ethanol, n- or isopropanol, n-, sec-, iso- or tert-butanol, a pentanol or a hexanol.

Examples of suitable cyclic or acyclic ethers having 4 to 8 carbon atoms are diethyl ether, methyl tert-butyl ether, diisopropyl ether, di-n-butyl ether, tetrahydrofuran or dioxane.

Examples of suitable cyclic or acyclic ketones having 3 to 8 carbon atoms are acetone, butanone or cyclohexanone.

Particular preference is given to using ethanol as the solvent in process step (a).

In a preferred form, the Sn(II) salt is optionally initially charged in a solvent, and the novolac is added, optionally in a solvent. In a further preferred form, the novolac is optionally initially charged in a solvent and the Sn(II) salt is added, optionally in a solvent.

The Sn(II) salts usable in the process according to the invention are known in principle to those skilled in the art. These may be salts derived either from inorganic or organic Brønsted acids. Preference is given to using those Sn(II) salts which dissolve in a melt of the novolac used or preferably dissolve in the same solvent as the novolac used.

Preferably, in the process according to the invention, the Sn(II) salt is selected from the group of salts consisting of SnCl₂, SnBr₂, Sn(acetate)₂, Sn oxalate, SnSO₄, Sn(NO₃)₂ and mixtures of these salts and hydrates thereof; particular preference is given to SnCl₂ and Sn(acetate)₂.

The reaction between the novolac and the Sn(II) salt forms an acid from a proton of a hydroxyl group of the novolac and an anion of the Sn(II) salt. The acid which forms can be scavenged with a suitable base, which is selected by the person skilled in the art typically on the basis of its solubility in the reaction system.

In a further preferred variant of the process according to the invention, process step (a) is performed in the presence of a base. The bases used may, for example, as well as alkali metal alkoxides, alkali metal hydroxides, alkali metal carbonates and alkali metal hydrogencarbonates, also be ammonia or primary, secondary or tertiary amines. Examples are NaOCH₃, KO-tC₄H₉, NaOH, KOH, LiOH, Na₂CO₃, K₂CO₃, Li₂CO₃, NaHCO₃, KHCO₃, (CH₃)₃N, (C₂H₅)₃N, morpholine, piperidine.

The sequence of addition is variable within wide limits. For instance, the novolac can be initially charged, the base can be added and then the Sn compound, or Sn compound and base, are added separately but simultaneously to a preparation of the novolac.

It is equally possible to initially charge the novolac, and to add the Sn compound and then the base. In addition, it is possible to add a novolac/base mixture to a preparation of the Sn compound, or novolac and base are added separately but simultaneously to a preparation of the Sn compound.

In the process according to the invention, the ratio of the Sn(II) salt to the novolac can in principle be varied within a wide range. In order to obtain an Sn(II)-crosslinked novolac material, an Sn(II) theoretically reacts with two hydroxyl groups from the novolac. Due to the chelate effect of two hydroxyl groups bonded adjacently to an aryl unit, it is possible to imagine that Sn(II) is preferentially bound within such an environment.

In order to avoid the formation of tin oxides outside the polymer matrix, preference is given to reacting only such amounts of Sn(II) salt with novolac that the tin is actually bound within the polymer matrix to an extent of more than 50%, preferably to an extent of more than 70%, more preferably to an extent of more than 90% up to 100%. According to the solvent, the proportion of the tin bound within the polymer matrix may also vary given the same starting ratios of Sn(II) salt to novolacs, since, for example, in water, simple tin oxide formation competes with the reaction of the Sn(II) salt with the hydroxyl groups of the novolac.

In a preferred embodiment of the process according to the invention, the molar ratio of the Sn(II) salt to the aryl units from the novolac which bear two, three or four hydroxyl groups, with at least two hydroxyl groups adjacent to one another, is from 0.05:1 to 1:1. In a further preferred form, the ratio is 0.1:1 to 0.9:1, preferably 0.2:1 to 0.7:1, more preferably 0.3:1 to 0.6:1.

Both in the course of production of an Sn(II)-crosslinked novolac material and in the electroactive material which is obtainable from the Sn(II)-crosslinked novolac material by carbonization and which comprises a carbon phase C and a tin phase and/or tin oxide phase, it is possible to supplement the tin with one or more metals or semimetals. If reference is made above and below to tin or Sn or Sn(II), this always also comprises mixtures which comprise 0.1-50%, 1-45%, 5-40% or 10-30% of one or more metals or semimetals. Whether the unit “%” means percentages by weight, atom percentages or molar percentages becomes clear from the particular context.

Where compounds are involved, the “non-(semi)metallic portion”—i.e., for example, the counterion—may be the same (e.g. SnCl₂ and SbCl₃) or different (e.g. SnCl₂ and Pb(NO₃)₂).

The semimetal(s) may belong to group 1, 2, 3, 4, 5, 6, 7, 8, 9, 10, 11, 12, 13, 14 or 15 of the Periodic Table of the Elements. Examples are: Li, Mg, Ca, La, Ti, V, Mo, Mn, Fe, Co, Ni, Cu, Ag, Zn, Al, Si, Ge, Pb, As, Sb, Bi.

In one embodiment, a mixture of Sn and Co is present where the composition may vary within the limits specified and comprises, for example, the range of Sn/Co weight ratios from 65/35 to 85/15.

In a further embodiment, a mixture of Sn and Fe is present where the composition may vary within the limits specified and comprises, for example, the range of Sn/Fe weight ratios from 65/35 to 85/15.

In a further embodiment, a mixture of Sn and Mn is present where the composition may vary within the limits specified and comprises, for example, the range of Sn/Mn weight ratios from 65/35 to 85/15.

In a further embodiment, a mixture of Sn and Cu is present where the composition may vary within the limits specified and comprises, for example, the range of Sn/Cu weight ratios from 40/60 to 80/20.

In the optional process step (b) of the process according to the invention, an Sn(II)-crosslinked novolac material possibly formed in the form of a powder can be isolated. Preferably, the means of isolation of the Sn(II)-crosslinked novolac material formed in the form of a powder arises when process step (a) has been performed in a solvent in which the novolac was at first present in dissolved form, and an Sn(II)-crosslinked novolac material is only obtained in the solvent in the form of a powder through reaction with the Sn(II) salt.

The Sn(II)-crosslinked novolac material isolated in the form of a powder in a preferred embodiment of the process according to the invention has a mean particle size from 1 to 100 μm, preferably from 10 to 60 μm, especially from 15 to 50 μm.

Methods for isolation of the Sn(II)-crosslinked novolac material in the form of a powder are known to those skilled in the art. Possible examples are filtration methods or centrifugation, the isolated material optionally being further purifiable by further process steps, such as washing and drying steps.

The present invention further also provides an Sn(II)-crosslinked novolac material obtainable by reacting a novolac comprising aryl units which bear two, three or four hydroxyl groups, with at least two hydroxyl groups adjacent to one another, and which are joined to further aryl units via at least one substituted or unsubstituted alkylene group, with at least one Sn(II) salt, especially in a solvent.

Preferred embodiments with regard to the novolac used, the Sn(II) salt, the reaction conditions and the form in which the Sn(II)-crosslinked novolac material is obtainable correspond, with regard to the inventive Sn(II)-crosslinked novolac material, to the preferred embodiments described above in connection with the process according to the invention.

The inventive Sn(II)-crosslinked novolac material can be described in detail especially by the following structure section of the formula (I)

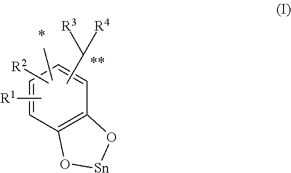

in which
R¹ and R² may be the same or different and are each hydrogen, hydroxyl, halogen or an organic radical having 1 to 20 carbon atoms, especially hydrogen,
R³ and R⁴ may be the same or different and are each hydrogen or an organic radical having 1 to 20 carbon atoms, especially hydrogen,

the carbon atom bearing * is bonded to a hydrogen atom or to a divalent C(R³)(R⁴) radical which is joined to a further aryl unit, and the carbon atom labeled ** to a further aryl unit.

The expression “organic radical having 1 to 20 carbon atoms”, as used above, refers, for example, to C₁-C₂₀-alkyl radicals, saturated C₃-C₂₀-heterocyclic radicals, C₆-C₂₀-aryl radicals, C₂-C₂₀-heteroaromatic radicals or C₇-C₂₀-arylalkyl radicals, where the carbon-containing radical may comprise further heteroatoms selected from the group of the elements consisting of F, Cl, Br, I, N, P, Si, O and S, and/or may be substituted by functional groups.

The expression “saturated heterocyclic radical”, as used above, refers, for example, to mono- or polycyclic, substituted or unsubstituted hydrocarbyl radicals in which one or more carbon atoms, CH groups and/or CH₂ groups are replaced by heteroatoms, preferably selected from the group consisting of the elements O, S, N and P. Preferred examples of substituted or unsubstituted saturated heterocyclic radicals are pyrrolidinyl, imidazolidinyl, pyrazolidinyl, piperidyl, piperazinyl, morpholinyl, tetrahydrofuranyl, tetrahydropyranyl, tetrahydrothiophenyl and the like, and derivatives thereof substituted by methyl, ethyl, propyl, isopropyl and tert-butyl radicals.

The R¹ and R² radicals may be the same or different and are each hydrogen, hydroxyl, halogen, such as fluorine, chlorine, bromine or iodine, or an organic radical having 1 to 20 carbon atoms, for example C₁-C₂₀-alkyl, especially methyl, ethyl, tert-butyl, C₆-C₂₀-aryl, especially phenyl, arylalkyl or alkylaryl having 1 to 10 and preferably 1 to 4 carbon atoms in the alkyl radical, and 6 to 14, preferably 6 to 10 and especially 6 carbon atoms in the aryl radical, a saturated heterocyclic radical having 3 to 20 carbon atoms, or a heteroaromatic radical having 3 to 20 carbon atoms with in each case at least one heteroatom selected from the group consisting of the elements N, P, O and S, especially N, O and S, where the heteroaromatic radical may be substituted by further R¹⁰ radicals, where R¹⁰ is an organic radical having 1 to 10 and especially 1 to 6 carbon atoms, for example C₁-C₄-alkyl, C₆-C₁₀-aryl, arylalkyl or alkylaryl having 1 to 4 carbon atoms in the alkyl radical, and 6 to 10 and preferably 6 carbon atoms in the aryl radical, and two or more R¹⁰ radicals may be the same or different.

Preferably, the R¹ and R² radicals are the same and are each hydrogen.

The R³ and R⁴ radicals may be the same or different and are each hydrogen, or an organic radical having 1 to 20 carbon atoms, for example C₁-C₂₀-alkyl, especially methyl, C₆-C₂₀-aryl, especially phenyl, arylalkyl or alkylaryl having 1 to 10 and preferably 1 to 4 carbon atoms in the alkyl radical, and 6 to 14, preferably 6 to 10 and especially 6 carbon atoms in the aryl radical, a saturated heterocyclic radical having 3 to 20 carbon atoms, especially tetrahydrofuranyl, or a heteroaromatic radical having 3 to 20 carbon atoms with in each case at least one heteroatom selected from the group consisting of the elements N, P, O and S, especially N, O and S, where the heteroaromatic radical may be substituted by further R¹⁰ radicals, where R¹⁰ is an organic radical having 1 to 10 and especially 1 to 6 carbon atoms, for example C₁-C₄-alkyl, C₆-C₁₀-aryl, arylalkyl or alkylaryl having 1 to 4 carbon atoms in the alkyl radical, and 6 to 10 and preferably 6 carbon atoms in the aryl radical, and two or more R¹⁰ radicals may be the same or different.

Preferably, the R³ and R⁴ radicals are the same or different and are each hydrogen, methyl, phenyl or tetrahydrofuranyl, more preferably hydrogen or tetrahydrofuranyl.

More particularly, the R³ and R⁴ radicals are the same and are each hydrogen.

The further aryl units as used above are, as described above in the process according to the invention for preparing an Sn(II)-crosslinked novolac material, aryl units which are either identical to the aryl units which bear two, three or four hydroxyl groups, with at least two hydroxyl groups adjacent to one another, or are those aryl units which derive from other optionally substituted phenols such as phenol, o-cresol, p-cresol, p-tert-butylphenol as the phenol component.

One process variant which is also possible is to react the optionally substituted phenol in a first process step with an excess of aldehyde or ketone, for example (para)formaldehyde, trioxane, acetaldehyde, furfural or else acetone, and to condense the resulting intermediate with an optionally further-substituted 1,2-dihydroxybenzene. For example, p-cresol can be reacted with formaldehyde to give 2,6-bis(hydroxymethyl)-4-methylphenol, which is then condensed with catechol to give the novolac.

In a specific embodiment, the organic component of the hybrid material reacts with crosslinkers. Such novolac crosslinkers as urotropin, 2,6-dimethylol-4-methylphenol or 2,2′-bis(3,5-dimethylol-4-hydroxyphenyl)propane are known to those skilled in the art and are also described in the specialist literature cited. To this end, a crosslinker can be added to the novolac before the reaction with the metal or the reaction product of novolac and metal can be reacted with a crosslinker in an additional step.

Preference is given to an inventive Sn(II)-crosslinked novolac material as described above, in which the R¹, R², R³ and R⁴ radicals in formula (I) are each hydrogen, where the proportion of the aryl units in the novolac which corresponds to the aryl unit shown in the structure section of the formula (I) (called proportion A) may differ according to the task. For novolacs with high metal affinity, proportion A is at least 50 mol %, preferably at least 80 mol %, especially at least 95 up to 100 mol %. For novolacs with moderate metal affinity, ranges of 20-40% or 30-50% will be preferred for proportion A, whereas novolacs with a low metal affinity have a proportion A in the range of 5-15% or 10-25%.

The object discussed at the outset is also achieved by a process for producing an electroactive material comprising
i) a carbon phase C;
ii) at least one SnOₓ phase in which x is a number from 0 to 2;

the carbon phase C and the SnOₓ phase forming essentially co-continuous phase domains, the mean distance between two adjacent domains of identical phases being not more than 10 nm, or the SnOₓ phase where x is less than 0.2 being in the form of SnOₓ domains embedded essentially in isolation in a continuous carbon phase C as a matrix, in which more than 50% of the SnOₓ domains have a size in the range from 1 nm to 20 μm, comprising the process steps of
(a) reacting at least one novolac comprising aryl units which bear two, three or four hydroxyl groups, with at least two hydroxyl groups adjacent to one another, and which are joined to further aryl units via at least one substituted or unsubstituted alkylene group, with at least one Sn(II) salt to give an Sn(II)-crosslinked novolac material,
(b) optionally isolating the Sn(II)-crosslinked novolac material formed in the form of a powder, and
(c) carbonizing the Sn(II)-crosslinked novolac material and optionally partially or fully reducing Sn(II) to Sn(0).

The process for producing an electroactive material comprises process step (a) and optionally process step (b), which have already been described in detail above in the process according to the invention for producing an Sn(II)-crosslinked novolac material.

In a preferred embodiment, the process for producing an electroactive material, with regard to process steps (a) and/or (b), is therefore performed in one of the above-described embodiments for production of an Sn(II)-crosslinked novolac material.

In process step (c) of the process according to the invention for producing an electroactive material, carbonization of the Sn(II)-crosslinked novolac material and optionally partial or full reduction of Sn(II) to Sn(0) is performed.

In general, the carbonization is performed at a temperature in the range from 200 to 2000° C., preferably in the range from 300 to 1600° C., more preferably in the range from 400 to 1100° C., especially in the range from 500 to 900° C.

In one embodiment, carbonization is effected at temperatures in the lower range, for example below 600° C., below 500° C. or around 400° C. With this method, it is possible to obtain wide areas of the co-continuous structures.

In a further embodiment, carbonization is effected at temperatures in the higher range, for example above 700° C., above 800° C. or around 1000° C. This method can be used to produce wide areas of isolated metal particles in a carbon matrix, for which it is advantageously possible to use reducing gases.

The duration for the carbonization may vary within a wide range and depends on factors including the temperature at which the carbonization is performed. The time for the carbonization may be from 0.5 to 50 h, preferably from 1 to 24 h, especially 2 to 12 h. In many cases, heating up to the desired temperature was effected at a rate of 1-10° C./min, preferably 2-6° C./min, i.e., for example, at 2, 3 or 4° C./min. The cooling may be commenced straight after the attainment of this temperature, or this temperature can be held for 10 min to 10 h. This hold time may, for example, be about 0.5 h; 1 h; 2 h; 3 h; 4 h or 5 h.

In a further embodiment, a heat treatment step is inserted before the carbonizing process. This can be accomplished by keeping the temperature (for example approx. 200° C. or approx. 250° C.) constant within a temperature range of 100° C.-400° C., preferably 150° C.-300° C., until the heat treatment step is complete, i.e., for example, for approx. 1 h or approx. 2 h. It is also possible to lower the heating rates within the temperature range of 100° C.-400° C., preferably 150° C.-300° C.; for example to ½ or ⅓ of the heating rate chosen.

The carbonization of the Sn(II)-crosslinked novolac material can in principle be performed in one or more stages, for example one or two stages. In principle, one step of the carbonization can be performed in the presence or absence of oxidizing agents, for example oxygen, provided that the oxidizing agent does not fully oxidize the carbon present in the Sn(II)-crosslinked novolac material. In order to very substantially suppress the oxidation of the carbon present in the Sn(II)-crosslinked novolac material, it has been found to be advantageous to perform the carbonization with substantial or complete exclusion of oxygen, preferably in the presence of inert gases or reducing gases (reactive gas). In a multistage carbonization process, the different steps can be performed in the presence of different gases and/or at different temperatures. For example, a first step can be performed in the presence of an inert gas such as argon or nitrogen, and a second step in the presence of a reducing gas (reactive gas) such as hydrogen, ammonia, carbon monoxide or acetylene and mixtures thereof, for example synthesis gas (CO/H₂) or forming gas (N₂/H₂ or Ar/H₂).

The carbonization of the Sn(II)-crosslinked novolac material can in principle be performed under reduced pressure, for example under vacuum, under standard pressure or under elevated pressure, for example in a pressure autoclave. In general, the carbonization is performed at a pressure in the range from 0.01 to 100 bar, preferably in the range from 0.1 to 10 bar, especially in the range from 0.5 to 5 bar or 0.7 to 2 bar. The carbonization can be performed in a closed system or in an open system in which volatile constituents which form are removed in a gas stream, inert gases or reducing gases.

In a preferred embodiment of the process according to the invention for producing an electroactive material, the carbonization of the Sn(II)-crosslinked novolac material in process step (c) is therefore performed in one or more stages, preferably in one stage, with substantial or complete, preferably complete, exclusion of oxygen. Complete exclusion of oxygen means in this context that not more than 0.5% by volume, preferably less than 0.05% by volume and especially less than 0.01% by volume of oxygen is present in the gas space.

In a further preferred embodiment of the process according to the invention for producing an electroactive material, the carbonization of the Sn(II)-crosslinked novolac material in process step (c) is performed in the presence of a protective or reactive gas selected from Ar, N₂, H₂, NH₃, CO and C₂H₂, and mixtures thereof.

In process step (c), in addition, depending on the conditions employed, the Sn(II) bound within the Sn(II)-crosslinked novolac material can be converted to an SnOₓ phase in which x is a number from 0 to 2. Preference is given, however, to an electroactive material in which “tin” is present at least partly in the form of Sn(0), preferably in metallic form. Therefore, the electroactive material more preferably has SnOₓ phases in which x is less than 1, preferably less than 0.4, more preferably less than 0.2, especially less than 0.05. The conversion of the Sn(II) originally present to Sn(0) preferably takes place in the presence of a reducing gas, also called reactive gas here, as detailed above.

In a further preferred embodiment of the process according to the invention for producing an electroactive material, therefore, the partial or full reduction of Sn(II) to Sn(0) in process step (c) is performed in the presence of a reactive gas selected from H₂, NH₃, CO and C₂H₂, and mixtures thereof.

In the process according to the invention for producing an electroactive material, by appropriate selection of the Sn(II)-crosslinked novolac material and the conditions during the carbonization in process step (c), the tin content in the electroactive material can be varied within a wide range. In principle, a value for the tin content can be varied from virtually 0% by weight, which means that only traces of tin are present in the carbon phase C, up to virtually 100% by weight, which means that only traces of a carbon phase C are present in metallic tin (Sn(0)), the percentage by weight being based on the total mass of the electroactive material.

Preferably, however, the process according to the invention produces an electroactive material wherein the tin content is 5 to 90% by weight, preferably 10 to 75% by weight, more preferably 15 to 55% by weight and especially 20 to 40% by weight, based on the total mass of the electroactive material.

More particularly, the process according to the invention is suitable for industrial production of electrode materials in continuous and/or batchwise mode. In batchwise mode, this means batch sizes above 10 kg, better >100 kg, even better >1000 kg or >5000 kg. In continuous mode, this means production volumes of more than 100 kg/day, better >1000 kg/day, even better >10 t/day or >100 t/day.

The process and the materials produced thereby are also notable in that it is possible in accordance with the invention to produce battery cells which are stable preferably over at least 5 cycles, more preferably over at least 10 cycles, even more preferably over at least 50 cycles, especially over at least 100 cycles or over at least 500 cycles.

The present invention further also provides an electroactive material obtainable by the process according to the invention for producing an electroactive material as described above. This process comprises the above-described process steps a), b) and c), especially also with regard to preferred embodiments thereof.

The present invention likewise also provides an electroactive material comprising
i) a carbon phase C;
ii) at least one SnOₓ phase in which x is a number from 0 to 2;

the carbon phase C and the SnOₓ phase forming essentially co-continuous phase domains, the mean distance between two adjacent domains of identical phases being not more than 10 nm, particularly not more than 5 nm and especially not more than 2 nm, or the SnOₓ phase where x is less than 0.2 being in the form of SnOₓ domains embedded essentially in isolation in a continuous carbon phase C as a matrix, in which more than 50% of the SnOₓ domains have a size in the range from 1 nm to 20 μm, wherein the tin content in the electroactive material is 5 to 90% by weight, preferably 10 to 75% by weight, more preferably 15 to 55% by weight and especially 20 to 40% by weight, based on the total mass of the electroactive material.

In a preferred embodiment, both the above-described inventive electroactive material and the electroactive material which is obtainable by the corresponding process according to the invention and is described further up are notable in that the number x of the SnOₓ phase of the electroactive material is a number less than 0.2, preferably less than 0.1 and especially less than 0.05.

The inventive electroactive material comprises a carbon phase C. In this phase, the carbon is present essentially in elemental form, which means that the proportion of non-carbon atoms in the phase, e.g. N, O, S, P and/or H, is less than 10% by weight, especially less than 5% by weight, based on the total amount of carbon in the phase. The content of non-carbon atoms in the phase can be determined by means of X-ray photoelectron spectroscopy. As well as carbon, the carbon phase, as a result of the preparation, may especially comprise small amounts of nitrogen, oxygen and/or hydrogen. The molar ratio of hydrogen to carbon will generally not exceed a value of 1:2, particularly a value of 1:3 and especially a value of 1:4. The value may also be 0 or virtually 0, for examples 0.1.

In the carbon phase C, the carbon is probably present predominantly in amorphous or graphitic form, as can be concluded on the basis of ESCA analyses from the characteristic binding energy (284.5 eV) and the characteristically asymmetric signal shape. Carbon in graphitic form is understood to mean that the carbon is at least partly present in a hexagonal layer arrangement typical of graphite, and it is also possible for the layers to be bent or exfoliated.

The inventive electroactive material further comprises a phase with the stoichiometry SnOₓ, i.e. a phase consisting essentially of tin present in oxidic and/or elemental form. As described above, in a preferred embodiment, the number x of the SnOₓ phase of the electroactive material is a number less than 0.2, preferably less than 0.1, especially less than 0.05.

In the inventive electroactive materials, the molar ratio of tin atoms Sn to the carbon atoms C, i.e. the molar Sn:C ratio, may vary over wide ranges and is preferably in the range from 1:1200 to 1:3, especially in the range from 1:500 to 1:7.

In one embodiment, the carbon phase C and the SnOₓ phase in the inventive electroactive materials are present in a cocontinuous arrangement over wide ranges, which means that the particular phase essentially does not form any isolated phase domains surrounded by a possibly continuous phase domain. Instead, the two phases form continuous phase domains which are spatially separated from one another and penetrate one another, as can be seen by analysis of the materials by means of transmission electron microscopy. With regard to the terms “continuous phase domain”, “discontinuous phase domain” and “cocontinuous phase domain”, reference is also made to W.J. Work et al., Definitions of Terms Related to Polymer Blends, Composites and Multiphase Polymeric Materials, (IUPAC Recommendations 2004), Pure Appl. Chem., 76 (2004), p. 1985-2007, especially p. 2003. According to this, a cocontinuous arrangement of a two-component mixture is understood to mean a phase-separated arrangement of the two phases or components, in which within one domain of the particular phase a continuous path through either phase domain may be drawn to all phase domain boundaries without crossing any phase domain boundary.

In the inventive electroactive materials, the regions in which the carbon phase and the SnOₓ phase form essentially cocontinuous phase domains make up preferably at least 50% by volume, more preferably at least 60% by volume, even more preferably at least 70% by volume, exceptionally preferably at least 80% by volume, especially at least 90% by volume to a maximum of 100% by volume of the electroactive material.

In the above-described embodiment, the distances between adjacent phase boundaries or the distances between the domains of adjacent identical phases in the inventive electroactive materials are small and are on average not more than 10 nm, particularly not more than 5 nm and especially not more than 2 nm. The distance between adjacent identical phases is understood to mean, for example, the distance between two domains of the SnOₓ phase which are separated from one another by a domain of the carbon phase C, or the distance between two domains of the carbon phase C which are separated from one another by a domain of the SnOₓ phase. The mean distance between the domains of adjacent identical phases can be determined by means of small-angle X-ray scattering (SAXS) via the scatter vector q (measurement in transmission at 20° C., monochromatized CuK_{α} radiation, 2D detector (image plate), slit collimation).

In a further embodiment, Sn particles are embedded into a matrix of carbon. In this further embodiment, the SnOₓ phase where x is less than 0.2, preferably less than 0.1 and especially less than 0.05 is present in the form of SnOₓ domains, which can also be referred to as Sn particles, where the SnOₓ domains (Sn particles) are embedded in an essentially isolated manner in a continuous carbon phase C as the matrix, in which more than 50%, preferably >70%, more preferably >80%, especially >90% to a maximum of 100% of the SnOₓ domains (Sn particles) have a size in the range from 1 nm to 20 μm, preferably in the range from 2 nm to 2 μm, more preferably in the range from 3 nm to 500 nm, even more preferably in the range from 4 nm to 100 nm, especially in the range from 10 to 60 nm, for example approx. 10 nm, approx. 20 nm or approx. 40 nm or approx. 5 nm.

The desired geometries can be established via the selection of the precipitation and calcination parameters.

The size of the phase regions and hence the distances between adjacent phase boundaries and the arrangement of the phase can also be determined by transmission electron microscopy, especially by means of the HAADF-STEM technique (HAADF-STEM=high angle annular darkfield scanning electron microscopy). In this imaging technique, comparatively heavy elements (for example Sn compared to C) appear brighter than lighter elements. Preparation artifacts can likewise be recognized since denser regions of the preparations appear brighter than less dense regions.

Due to its composition and the specific arrangement of the carbon phase C and of the SnOₓ phase, the inventive electroactive material is particularly suitable as a material for anodes in Li ion cells, especially in Li ion secondary cells or batteries. More particularly, in the case of use in anodes of Li ion cells and especially of Li ion secondary cells, it is notable for high capacity and good cycling stability, and ensures low impedances in the cell. In addition, probably due to the specific phase arrangement, it has a high mechanical stability. Moreover, it can be produced in a simple manner and with reproducible quality.

The present invention further also provides for the use of the inventive electroactive material as described above as a constituent of an electrode for an electrochemical cell.

The present invention likewise accordingly also provides an electrode for an electrochemical cell comprising the inventive electroactive material as described above. This electrode is typically incorporated and used as the anode in an electrochemical cell. Therefore, the electrode which comprises the inventive electroactive material is also referred to hereinafter as the anode.

In addition to the inventive electroactive material, the anode generally comprises at least one suitable binder for consolidation of the inventive electroactive material, and optionally further electrically conductive or electroactive constituents. In addition, the anode generally has electrical contacts for supply and removal of charges. The amount of inventive electroactive material, based on the total mass of the anode material, minus any current collectors and electrical contacts, is generally at least 40% by weight, frequently at least 50% by weight and especially at least 60% by weight.

Useful further electrically conductive or electroactive constituents in the inventive anodes include carbon black, graphite, carbon fibers, carbon nanofibers, carbon nanotubes or electrically conductive polymers. Typically, about 2.5 to 40% by weight of the conductive material are used in the anode together with 50 to 97.5% by weight, frequently with 60 to 95% by weight, of the inventive electroactive material, the figures in percent by weight being based on the total mass of the anode material, minus any current collectors and electrical contacts.

Useful binders for the production of an anode using the inventive electroactive materials include especially the following polymeric materials:

polyethylene oxide (PEO), cellulose, carboxymethylcellulose, polyvinyl alcohol, polyethylene, polypropylene, polytetrafluoroethylene, polyacrylonitrile-methyl methacrylate copolymers, styrene-butadiene copolymers, tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers, ethylene-chlorofluoroethylene copolymers, ethylene-acrylic acid copolymers, optionally at least partly neutralized with alkali metal salt or ammonia, ethylene-methacrylic acid copolymers, optionally at least partially neutralized with alkali metal salt or ammonia, ethylene-(meth)acrylic ester copolymers, polyimides and polyisobutene.

The selection of the binder is optionally made with consideration of the properties of any solvent used for production. The binder is generally used in an amount of 1 to 10% by weight, based on the overall mixture of the anode material. Preference is given to using 2 to 8% by weight, especially 3 to 7% by weight.

The inventive electrode comprising the inventive electroactive material, also referred to above as anode, generally comprises electrical contacts for supply and removal of charges, for example an output conductor, which may be configured in the form of a metal wire, metal grid, metal mesh, expanded metal, or of a metal foil or a metal sheet. Suitable metal foils are especially copper foils.

In one embodiment of the present invention, the anode has a thickness in the range from 15 to 200 μm, preferably from 30 to 100 μm, based on the thickness without output conductor.

The anode can be produced in a manner customary per se by standard methods as known from the prior art cited at the outset and from relevant monographs. For example, the anode can be produced by mixing the inventive electroactive material, optionally using an organic solvent (for example N-methylpyrrolidinone or a hydrocarbon solvent), with the optional further constituents of the anode material (electrically conductive constituents and/or organic binder), and optionally subjecting it to a shaping process or applying it to an inert metal foil, for example Cu foil: This is optionally followed by drying. This is done, for example, using a temperature of 80 to 150° C. The drying operation can also take place under reduced pressure and lasts generally for 3 to 48 hours. Optionally, it is also possible to employ a melting or sintering process for the shaping.

The present invention further also provides an electrochemical cell, especially a lithium ion secondary cell, comprising at least one electrode which has been produced from or using an electrode material as described above.

Such cells generally have at least one inventive anode, a cathode, especially a cathode suitable for lithium ion cells, an electrolyte and optionally a separator.

With regard to suitable cathode materials, suitable electrolytes, suitable separators and possible arrangements, reference is made to the relevant prior art, for example the prior art cited at the outset, and to appropriate monographs and reference works: for example Wakihara et al. (editor) in Lithium Ion Batteries, 1st edition, Wiley VCH, Weinheim, 1998; David Linden: Handbook of Batteries (McGraw-Hill Handbooks), 3rd edition, McGraw-Hill Professional, New York 2008; J. O. Besenhard: Handbook of Battery Materials, Wiley-VCH, 1998.

Useful cathodes include especially those cathodes in which the cathode material comprises lithium transition metal oxide, e.g. lithium cobalt oxide, lithium nickel oxide, lithium cobalt nickel oxide, lithium manganese oxide (spinel), lithium nickel cobalt aluminum oxide, lithium nickel cobalt manganese oxide or lithium vanadium oxide, or a lithium transition metal phosphate such as lithium iron phosphate. If the intention, however, is to use those cathode materials which comprise sulfur and polymers comprising polysulfide bridges, it has to be ensured that the anode is charged with Li⁰ before such an electrochemical cell can be discharged and recharged.

The two electrodes, i.e. the anode and the cathode, are connected to one another using a liquid or else solid electrolyte. Useful liquid electrolytes include especially nonaqueous solutions (water content generally <20 ppm) of lithium salts and molten Li salts, for example solutions of lithium hexafluorophosphate, lithium perchlorate, lithium hexafluoroarsenate, lithium trifluoromethylsulfonate, lithium bis(trifluoromethylsulfonyl)imide or lithium tetrafluoroborate, especially lithium hexafluorophosphate or lithium tetrafluoroborate, in suitable aprotic solvents, for example ethylene carbonate, propylene carbonate and mixtures thereof with one or more of the following solvents: dimethyl carbonate, ethyl methyl carbonate, diethyl carbonate, dimethoxyethane, methyl propionate, ethyl propionate, butyrolactone, acetonitrile, ethyl acetate, methyl acetate, toluene and xylene, especially in a mixture of ethylene carbonate and diethyl carbonate. The solid electrolytes used may, for example, be ionically conductive polymers.

A separator impregnated with the liquid electrolyte may be arranged between the electrodes.

Examples of separators are especially glass fiber nonwovens and porous organic polymer films, such as porous films of polyethylene, polypropylene, PVdF etc.

Particularly suitable materials for separators are polyolefins, especially porous polyethylene films and porous polypropylene films.

Polyolefin separators, especially composed of polyethylene or polypropylene, may have a porosity in the range from 35 to 45%. Suitable pore diameters are, for example, in the range from 30 to 500 nm.

In another embodiment of the present invention, the separators selected may be separators composed of PET nonwovens filled with inorganic particles. Such separators may have a porosity in the range from 40 to 55%. Suitable pore diameters are, for example, in the range from 80 to 750 nm.

Inventive electrochemical cells typically further comprise a housing which may be of any shape, for example cuboidal, or the shape of a cylinder. In another embodiment, inventive electrochemical cells have the shape of a prism. In one variant, the housing used is a metal-plastic composite film elaborated as a pouch.

The cells may have, for example, a prismatic thin film structure, in which a solid thin film electrolyte is arranged between a film which constitutes an anode and a film which constitutes a cathode. A central cathode output conductor is arranged between each of the cathode films in order to form a double-faced cell configuration. In another embodiment, a single-faced cell configuration can be used, in which a single cathode output conductor is assigned to a single anode/separator/cathode element combination. In this configuration, an insulation film is typically arranged between individual anode/separator/cathode/output conductor element combinations.

Inventive electrochemical cells give a high voltage and are notable for high energy density and good stability. More particularly, inventive electrochemical cells are notable for only a very low loss of capacity in the course of prolonged use and repeated cycling.

The inventive electrochemical cells can be combined to form lithium ion batteries.

Accordingly, the present invention further also provides for the use of inventive electrochemical cells as described above in lithium ion batteries.

The present invention further provides lithium ion batteries comprising at least one inventive electrochemical cell as described above. Inventive electrochemical cells can be combined with one another in inventive lithium ion batteries, for example in series connection or in parallel connection. Series connection is preferred.

Inventive electrochemical cells are notable for particularly high capacities, high power even after repeated charging, and significantly delayed cell death. Inventive electrical cells are very suitable for use in automobiles, bicycles driven by electric motor, for example pedelecs, aircraft, ships or stationary energy stores. Such uses form a further part of the subject matter of the present invention.

The present invention further provides for the use of inventive electrochemical cells as described above in automobiles, bicycles driven by electric motor, aircraft, ships or stationary energy stores.

The use of inventive lithium ion batteries in appliances gives the advantage of a longer run time before recharging, and a smaller loss of capacity over prolonged run time. If an equal run time were to be achieved with the electrochemical cells with lower energy density, a higher weight for electrochemical cells would have to be accepted.

The present invention therefore further also provides for the use of inventive lithium ion batteries in appliances, especially in mobile devices. Examples of mobile devices are vehicles, for example automobiles, bicycles, aircraft, or water vehicles such as boats or ships. Other examples of mobile devices are those which are moved manually, for example computers, especially laptops, telephones or electrical hand tools, for example from the building sector, especially drills, battery-powered drills or battery-powered tackers.

The invention is illustrated by the examples which follow, which do not, however, restrict the invention.

### EXAMPLE 1

### Preparation of a Catechol Novolac

440 g of catechol and 20 g of oxalic acid were dissolved in 500 ml of water at 55° C. 240 g of 37% formaldehyde solution were added and the mixture was stirred at 80° C. over 3 h. Then the water was distilled off up to a bath temperature of 170° C. (inside 145° C.). Residues of water were driven out by water-jet vacuum. The resin was poured hot into a metal bowl.

460 g of a brown-black resin,

NMR (acetone-D6)

3.4-4.2 ppm methylene signals (2H); 6-7 ppm aromatic signals (3.2 H); additionally —OH signals (broad, 3 and 7.5-8.5 ppm)

### EXAMPLE 2

### Preparation of a Catechol/p-cresol Novolac

110 g of catechol, 324 g of p-cresol and 20 g of oxalic acid were dissolved in 500 ml of water at 55° C. 240 g of 37% formaldehyde solution were added and the mixture was stirred at 80° C. over 3 h. Then the water was distilled off up to a bath temperature of 170° C. (inside 145° C.). Residues of water were driven out by water-jet vacuum. The resin was poured hot into a metal bowl.

455 g of a brown-black resin,

NMR (acetone-D6)

1.8-2.4 ppm benzyl signals (3H); 3.4-4.2 ppm methylene signals (2H); 6-7 ppm aromatic signals (3.0H); additionally —OH signals (broad, 7.5-8.5 ppm)

### EXAMPLE 3

### Preparation of a Catechol/p-cresol Novolac

159 g of catechol and 10 g of oxalic acid were dissolved in 100 ml of water at 60° C. in a four-neck flask with a distillation apparatus. 147 g of 2,6-bis(hydroxymethyl)-4-methylphenol were added in 8 portions over 2 h, in the course of which the temperature was increased to 90° C. Then the water was distilled off up to a bath temperature of 140° C. (internal temperature 102° C.). Residues of water were driven off by water-jet vacuum (internal temperature 150° C.). The resin was poured hot into a metal bowl.

171 g of a brown-black resin,

NMR (methanol-D4)

1.8-2.4 ppm benzyl signals (3H); 3.4-4.2 ppm methylene signals (3.7H); 6-7 ppm aromatic signals (6.1H).

### EXAMPLE 4

### Precipitation in Water

61 g of the resin from Example 1 (corresponding to 0.5 mol of catechol units) were dissolved in 100 ml of water. 31 g of SnCl₂*2H₂O (0.125 mol) were added while stirring. 37.4 g of ammonia in water (0.55 mol of NH₃) were added dropwise and the mixture was stirred at RT for 30 min. The mixture was filtered with suction through a D3 frit and the solids were stirred 3× with 10% NH₃ solution in water. The filtercake was dried at 80° C./100 mbar in a vacuum drying cabinet.

80 g of light gray/greenish powder.

| | C | H | O | Sn |
|---|---|---|---|---|
| Found | 41.2 | 3.5 | 24.1 | 27.3 |
| Theory | 55 | 4.6 | 21 | 19.4 |

The powder comprises Sn oxide hydrates, which explains the excessively high O/H content.

### EXAMPLE 5

### Precipitation in an Organic Solvent

61 g of the resin from Example 1 (corresponding to 0.5 mol of catechol units) were dissolved in 200 ml of ethanol. 47 g of SnCl₂ (0.25 mol) in 100 ml of ethanol were added dropwise while stirring and the mixture was stirred at RT for 30 min. Then 55.6 g (0.55 mol) of triethylamine were added dropwise and the mixture was stirred for a further 30 min. The mixture was filtered with suction through a D3 frit and the solids were stirred with ethanol, 10% NH₃ solution in water and ethanol. The filtercake was dried at 80° C./100 mbar in a vacuum drying cabinet.

91 g of light gray, pale greenish powder.

| | C | H | O | Sn |
|---|---|---|---|---|
| Found | 43.8 | 5.0 | 16.0 | 25.9 |
| Theory | 46.9 | 2.2 | 17.8 | 33.1 |

### EXAMPLE 6

### Precipitation in an Organic Solvent

94.5 g of the resin from example 3 (corresponding to 0.5 mol of catechol units) were dissolved in 200 g of ethanol. 113 g of SnCl₂*2H₂O (0.5 mol) were added while stirring and the mixture was stirred at RT for 30 min. Then 68 g of 25% ammonia solution were added and the mixture was stirred for a further 30 min. The mixture was filtered through a D3 frit and the solids were aftertreated/stirred with ethanol, water and ethanol. The filtercake was dried at 80° C./100 mbar in a vacuum drying cabinet.

140 g of light gray powder.

| | C | H | O | Sn |
|---|---|---|---|---|
| Found | 40.4 | 4.2 | 28.8 | 25.2 |

In HAADF-STEM (High Angle Annular Dark Field—Scanning Transmission Electron Microscopy), the co-continuous hybrid structures with SnOx domains of size 1-2 nm were found. By means of EDXS (Energy Dispersive X-Ray Spectroscopy), it was shown that >90% of the Sn is present in an inorganic hybrid domain.

### EXAMPLE 7

### Calcination Under H₂

The samples were calcined in a tube furnace equipped with a gas-tight quartz tube, such that it was also possible to work in pure H₂ atmosphere without any safety problems.

11.1 g of the powder from Example 4 were heated to 650° C. in a quartz glass boat with a heating rate of 3-4° C./min under hydrogen (2-3 l/h) and kept at that temperature for 2 h. Then it was left to cool in an N₂ stream overnight.

7.1 g of black-gray powder.

| | C | H | O | Sn |
|---|---|---|---|---|
| Found | 53.7 | 1.5 | 1.9 | 42 |

### EXAMPLE 8

### Calcination Under Ar, then H₂

The samples were calcined in a tube furnace equipped with a gas-tight quartz tube, such that it was also possible to work in pure H₂ atmosphere without any safety problems.

11.5 g of the powder from Example 4 were heated to 780° C. in a quartz glass boat with a heating rate of 3-4° C./min under Ar (2-3 l/h) and kept at that temperature for 1.5 h. Then it was left to cool in an N₂ stream overnight.

Then it was heated to 400° C. at a heating rate of 3-4° C./min under H₂ (2-3 l/h) and kept at that temperature for 2 h. Then it was left to cool in an N₂ stream overnight.

7.4 g of black-gray powder.

| | C | H | O | Sn |
|---|---|---|---|---|
| Found | 56.3 | 0.6 | 1.8 | 40 |

### EXAMPLE 9

### Precipitation in an Organic Solvent

188 g of the resin from example 2 were dissolved in 200 ml of ethanol. 76 g of SnCl₂ (0.4 mol) in 200 ml of ethanol were added dropwise while stirring and the mixture was stirred at RT for 30 min. Then 81 g (0.8 mol) of triethylamine were added dropwise and the mixture was stirred for a further 30 min. The mixture was filtered with suction through a D3 frit and the solids were stirred with ethanol, NaHCO₃ solution in water and ethanol. The filtercake was dried at 80° C./100 mbar in a vacuum drying cabinet.

228 g of light gray powder.

| | C | H | Sn |
|---|---|---|---|
| Found | 53.8 | 5.5 | 19.2 |

### EXAMPLE 10

### Calcination Under H₂

9.7 g of the powder from example 9 were heated to 800° C. in a quartz glass boat at a heating rate of 3-4° C./min under hydrogen (2-3 l/h) and kept at that temperature for 2 h. Then it was left to cool in an N₂ stream overnight.

3.5 g of black powder (AM1).

Elemental analysis, figures in %

| | C | H | O | Sn | Total |
|---|---|---|---|---|---|
| Found | 48.4 | 0.7 | 1.2 | 49 | 99.3 |

### EXAMPLE 11

### Subsequent Crosslinking of a Precipitation Product

1 g of 2,2′-bis(3,5-dimethylol-4-hydroxyphenyl)propane were dissolved in 100 ml of ethanol and admixed with 10 g of the material from example 9. On a rotary evaporator, the alcohol was first removed at 60° C./10 mbar, then the residue was kept at 160° C. without vacuum for 1 h.

9 g of gray powder.

### EXAMPLE 12

### Calcination Under H₂

8.4 g of the powder from example 11 were heated to 800° C. in a quartz glass boat at a heating rate of 3-4° C./min under hydrogen (2-3 l/h) and kept at that temperature for 2 h. Then it was left to cool in an N₂ stream overnight.

3.7 g of black powder (AM2).

Elemental analysis, figures in %

| | C | H | O | Sn |
|---|---|---|---|---|
| Found | 54.8 | 0.8 | 1.0 | 43 |

### EXAMPLE 13

### Precipitation in an Organic Solvent with Addition of a Crosslinker

37.6 g of the resin from example 1 and 3 g of 2,6-dimethylol-4-methylphenol were dissolved in 300 ml of ethanol. 19 g of SnCl₂ (0.1 mol) in 100 ml of ethanol were added dropwise while stirring and the mixture was stirred at RT for 30 min. Then 22 g (0.26 mol) of triethylamine were added dropwise and the mixture was stirred for a further 30 min. The mixture was filtered with suction through a D3 frit and the solids were stirred with NaHCO₃ solution in water, water and methanol. The filtercake was dried on a rotary evaporator at 80° C./50 mbar.

52.8 g of light gray powder.

Elemental analysis, figures in %

| | C | H | Sn |
|---|---|---|---|
| Found | 48.7 | 4.9 | 19.7 |

### EXAMPLE 14

### Calcination Under H₂

7.5 g of the powder from example 13 were heated to 800° C. in a quartz glass boat at a heating rate of 3-4° C./min under hydrogen (2-3 l/h) and kept at that temperature for 2 h. Then it was left to cool in an N₂ stream overnight.

3.9 g of black powder (AM3).

Elemental analysis, figures in %

| | C | H | O | Sn |
|---|---|---|---|---|
| Found | 56.2 | 0.9 | 2.0 | 39 |

### EXAMPLE 15

### Precipitation in an Organic Solvent with Addition of a Crosslinker

47.6 g of the resin from example 2 and 3 g of 2,6-dimethylol-4-methylphenol were dissolved in 300 ml of ethanol. 19 g of SnCl₂ (0.1 mol) in 100 ml of ethanol were added dropwise while stirring and the mixture was stirred at RT for 30 min. Then 22 g (0.26 mol) of triethylamine were added dropwise and the mixture was stirred for a further 30 min. The mixture was filtered with suction through a D3 frit and the solids were stirred with NaHCO₃ solution in water, water and methanol. The filtercake was dried on a rotary evaporator at 80° C./50 mbar.

48.3 g of light gray powder.

Elemental analysis, figures in %

| | C | H | Sn |
|---|---|---|---|
| Found | 61.7 | 6.2 | 13.1 |

### EXAMPLE 16

### Calcination Under H₂

7.4 g of the powder from example 15 were heated to 800° C. in a quartz glass boat at a heating rate of 3-4° C./min under hydrogen (2-3 l/h) and kept at that temperature for 2 h. Then it was left to cool in an N₂ stream overnight.

3 g of black powder (AM4).

Elemental analysis, figures in %

| | C | H | O | Sn |
|---|---|---|---|---|
| Found | 64.4 | 1.0 | 1.2 | 33 |

### EXAMPLE 17

### Precipitation in an Organic Solvent in the Presence of Co and Sn Salts

50 g of the resin from example 1 were dissolved in 100 ml of ethanol. 13.3 g (0.1 mol) of CoCl₂ were added dropwise while stirring and the mixture was stirred at 40° C. for a further 30 min. Subsequently, 19.4 g of SnCl₂ (0.1 mol) in 100 ml of ethanol were added dropwise. Then 30 g (0.45 mol) of 25% ammonia solution were added dropwise and the mixture was stirred for a further 4 h. The mixture was filtered with suction through a D3 frit and the solids were stirred with water and ethanol. The filtercake was dried on a rotary evaporator at 100° C./50 mbar.

62.2 g of black powder.

| | C | H | Sn | Co |
|---|---|---|---|---|
| Found | 42.2 | 3.8 | 15.3 | 7.3 |

### EXAMPLE 18

### Calcination Under H₂

10.3 g of the powder from example 17 were heated to 980° C. in a quartz glass boat at a heating rate of 3-4° C./min under hydrogen (2-3 l/h) and kept at that temperature for 2 h. Then it was left to cool in an N₂ stream overnight.

5.9 g of black pyrophoric powder which was dispensed and stored under argon (AM5).

Elemental analysis, figures in %

| | C | H | O | Sn | Co |
|---|---|---|---|---|---|
| Found | 60.6 | 0.5 | 1.5 | 24.7 | 13.3 |

### EXAMPLE 19

### Preparation of a Catechol-p-cresol Novolac

220 g of catechol, 216 g of p-cresol and 20 g of oxalic acid were dissolved in 500 ml of water at 55° C. 243 g of 37% formaldehyde solution were added and the mixture was stirred at 80° C. over 3 h. Then the water was distilled off up to a bath temperature of 170° C. (internal temperature 150° C.). Residues of water were driven off by water-jet vacuum. The resin was poured hot into a metal bowl.

429 g of a brown-black resin,

NMR (acetone-D6)

1.8-2.4 ppm benzyl signals (3H); 3.4-4.2 ppm methylene signals (2H); 6-7 ppm aromatic signals (3.0H); additionally -OH signals (broad, 7.5-8.5 ppm)

### EXAMPLE 20

### Precipitation in an Organic Solvent in the Presence of Co and Sn Salts

47 g of the resin from example 19 were dissolved in 200 ml of toluene and 100 ml of ethanol, then 31.5 g (=384 mol) of N-methylimidazole were added. 11.7 g (0.09 mol) of CoCl₂ were added dropwise while stirring and the mixture was stirred at 40° C. for 30 min. Subsequently, 13.28 g of SnCl₂ (0.1 mol) in 100 ml of ethanol were added dropwise and the mixture was stirred for a further 1 h. The mixture was filtered with suction through a D3 frit and the solids were stirred with NaHCO₃ solution in water, water and methanol. The filtercake was dried on a rotary evaporator at 80° C./50 mbar.

50 g of black powder.

| | C | H | O | Sn | Co |
|---|---|---|---|---|---|
| Found | 53.0 | 4.5 | 17.9 | 13.7 | 2.5 |

### EXAMPLE 21

### Calcination Under H₂

7.5 g of the powder from example 20 were heated to 980° C. in a quartz glass boat at a heating rate of 3-4° C./min under hydrogen (2-3 l/h) and kept at that temperature for 2 h. Then it was left to cool in an N₂ stream overnight.

5.9 g of black pyrophoric powder which was dispensed and stored under argon (AM6).

Elemental analysis, figures in %

| | C | H | O | Sn | Co |
|---|---|---|---|---|---|
| Found | 65.7 | <0.5 | 0.5 | 27.5 | 5.8 |

### EXAMPLE 22

### Precipitation in an Organic Solvent in the Presence of Co and Sn Salts

47 g of the resin from example 1 were dissolved in 200 ml of ethanol, then 22 g (=0.26 mol) of triethylamine were added. 3.9 g (0.03 mol) of CoCl₂ were added dropwise while stirring and the mixture was stirred at 40° C. for 1 h. Subsequently, 13.3 g of SnCl₂ (0.1 mol) in 100 ml of ethanol were added dropwise and the mixture was stirred for a further 1 h. The mixture was filtered with suction through a D3 frit and the solids were stirred with NaHCO₃ solution in water, water and methanol. The filtercake was dried on a rotary evaporator at 80° C./50 mbar.

61.3 g of black powder.

Elemental analysis, figures in %

| | C | H | Sn | Co |
|---|---|---|---|---|
| Found | 48.9 | 5.5 | 12.1 | 2.5 |

### EXAMPLE 23

### Calcination Under H₂

7.2 g of the powder from example 22 were heated to 800° C. in a quartz glass boat at a heating rate of 3-4° C./min under hydrogen (2-3 l/h) and kept at that temperature for 2 h. Then it was left to cool in an N₂ stream overnight.

3.0 g of black pyrophoric powder which was dispensed and stored under argon (AM7).

Elemental analysis, figures in %

| | C | H | O | Sn | Co |
|---|---|---|---|---|---|
| Found | 57.1 | 0.8 | 3.4 | 29.2 | 6.1 |

### EXAMPLE 24

### Precipitation in an Organic Solvent in the Presence of Fe and Sn Salts

50 g of the resin from example 1 and 4.1 g of 2,6-dimethylol-4-methylphenol were dissolved in 300 ml of ethanol. 24.1 g of Fe-II acetate were dissolved in 1:1 ethanol/water and added dropwise. 24.8 g of SnCl₂ (0.13 mol) in 100 ml of ethanol were added dropwise while stirring and the mixture was stirred at RT for 30 min. Then 35.5 g (0.522 mol) of 25% ammonia were added dropwise and the mixture was stirred for a further 30 min. The mixture was filtered with suction through a D3 frit and extracted with sodium methoxide in methanol, water, ethanol and hexanol. The filtercake was dried at 100° C./3 mbar in a rotary evaporator.

61 g of dark-colored powder.

Elemental analysis, figures in %

| | C | H | Sn | Fe |
|---|---|---|---|---|
| Found | 35.5 | 2.8 | 18.0 | 8.2 |

### EXAMPLE 25

### Calcination Under H₂

14 g of the powder from example 24 were heated to 980° C. in a quartz glass boat at a heating rate of 3-4° C./min under hydrogen (2-3 l/h) and kept at that temperature for 2 h. Then it was left to cool in an N₂ stream overnight.

7.6 g of black pyrophoric powder which was dispensed and stored under argon (AM8).

Elemental analysis, figures in %

| | C | H | O | Sn | Fe |
|---|---|---|---|---|---|
| Found | 45.4 | <0.5 | 3.8 | 30 | 13.9 |

### Electrochemical Characterization

### EXAMPLE 26

### Characterization of AM1 from Example 10

The active material AM1 obtained in example 10 was subsequently blended with conductive black (Super P Li, Timcal) and binder (polyvinylidene fluoride, Kynarflex 2801) in order to obtain a viscous coating composition consisting of 85.4% by weight of the active material obtained in example 10, 5.4% by weight of conductive black and 9.2% by weight of binder in N-ethyl-2-pyrrolidone (NEP) solvent. The amount of solvent used was 125% by weight of the solids content used. For better homogenization, the coating composition was stirred by means of a magnetic stirrer for 16 hours. The coating composition was then applied by means of a film applicator (Erichsen Coatmaster 509 MC) to a 20 μm-thick Cu foil (purity 99.9%) in a coating bar process, and promptly introduced into a drying cabinet. Drying took place at 120° C. under reduced pressure overnight. After drying, the resulting electrodes (width 8 cm) were calendered with a linear pressure of 9 N/mm and then transferred to a glovebox (argon atmosphere, water content <1 ppm, oxygen content <10 ppm). Before building the cell, the electrodes were dried once again at 5 mbar and 120° C. overnight). For the building of the electrochemical test cells (2-electrode test arrangement analogous to a button cell), circular pieces with a diameter of 20 mm were punched out. A glass fiber separator (Whatman GF/D, thickness 630 μm) was used, and lithium foil was used as the counter electrode. The electrolyte used was 1 M LiPF₆ in a 1:1 mixture of ethylene carbonate and ethyl methyl carbonate. For electrochemical characterization, the cells were connected to a Maccor Series 4000 battery cycling tester. The cells were cycled at a specific current of 30 mA per gram of active material between 10 mV and 2 V against Li/Li⁺. After reaching 10 mV, the voltage was kept constant for 30 min.

### EXAMPLE 27

### Characterization of AM2 from Example 12

The active material AM2 obtained in example 12 was subsequently blended with conductive black (Super P Li, Timcal) and binder (polyvinylidene fluoride, Kynarflex 2801) in order to obtain a viscous coating composition consisting of 86.9% by weight of the active material obtained in example 12, 5.3% by weight of conductive black and 7.8% by weight of binder in N-ethyl-2-pyrrolidone (NEP) solvent. The amount of solvent used was 125% by weight of the solids content used. For better homogenization, the coating composition was stirred by means of a magnetic stirrer for 16 hours. The coating composition was then applied by means of a film applicator (Erichsen Coatmaster 509 MC) to a 20 μm-thick Cu foil (purity 99.9%) in a coating bar process, and promptly introduced into a drying cabinet. Drying took place at 120° C. under reduced pressure overnight. After drying, the resulting electrodes (width 8 cm) were calendered with a linear pressure of 9 N/mm and then transferred to a glovebox (argon atmosphere, water content <1 ppm, oxygen content <10 ppm). Before building the cell, the electrodes were dried once again at 5 mbar and 120° C. overnight). For the building of the electrochemical test cells (2-electrode test arrangement analogous to a button cell), circular pieces with a diameter of 20 mm were punched out. A glass fiber separator (Whatman GF/D, thickness 630 μm) was used, and lithium foil was used as the counter electrode. The electrolyte used was 1 M LiPF₆ in a 1:1 mixture of ethylene carbonate and ethyl methyl carbonate. For electrochemical characterization, the cells were connected to a Maccor Series 4000 battery cycling tester. The cells were cycled at a specific current of 30 mA per gram of active material between 10 mV and 2 V against Li/Li⁺. After reaching 10 mV, the voltage was kept constant for 30 min.

### EXAMPLE 28

### Characterization of AM3 from Example 14

The active material AM3 obtained in example 14 was subsequently blended with conductive black (Super P Li, Timcal) and binder (polyvinylidene fluoride, Kynarflex 2801) in order to obtain a viscous coating composition consisting of 85.3% by weight of the active material obtained in example 14, 6.2% by weight of conductive black and 8.5% by weight of binder in N-ethyl-2-pyrrolidone (NEP) solvent. The amount of solvent used was 125% by weight of the solids content used. For better homogenization, the coating composition was stirred by means of a magnetic stirrer for 16 hours. The coating composition was then applied by means of a film applicator (Erichsen Coatmaster 509 MC) to a 20 μm-thick Cu foil (purity 99.9%) in a coating bar process, and promptly introduced into a drying cabinet. Drying took place at 120° C. under reduced pressure overnight. After drying, the resulting electrodes (width 8 cm) were calendered with a linear pressure of 9 N/mm and then transferred to a glovebox (argon atmosphere, water content <1 ppm, oxygen content <10 ppm). Before building the cell, the electrodes were dried once again at 5 mbar and 120° C. overnight). For the building of the electrochemical test cells (2-electrode test arrangement analogous to a button cell), circular pieces with a diameter of 20 mm were punched out. A glass fiber separator (Whatman GF/D, thickness 630 μm) was used, and lithium foil was used as the counter electrode. The electrolyte used was 1 M LiPF₆ in a 1:1 mixture of ethylene carbonate and ethyl methyl carbonate. For electrochemical characterization, the cells were connected to a Maccor Series 4000 battery cycling tester. The cells were cycled at a specific current of 30 mA per gram of active material between 10 mV and 2 V against Li/Li⁺. After reaching 10 mV, the voltage was kept constant for 30 min.

### EXAMPLE 29

### Characterization of AM4 from Example 16

The active material AM4 obtained in example 16 was subsequently blended with conductive black (Super P Li, Timcal) and binder (polyvinylidene fluoride, Kynarflex 2801) in order to obtain a viscous coating composition consisting of 85% by weight of the active material obtained in example 16, 6.4% by weight of conductive black and 8.6% by weight of binder in N-ethyl-2-pyrrolidone (NEP) solvent. The amount of solvent used was 125% by weight of the solids content used. For better homogenization, the coating composition was stirred by means of a magnetic stirrer for 16 hours. The coating composition was then applied by means of a film applicator (Erichsen Coatmaster 509 MC) to a 20 μm-thick Cu foil (purity 99.9%) in a coating bar process, and promptly introduced into a drying cabinet. Drying took place at 120° C. under reduced pressure overnight. After drying, the resulting electrodes (width 8 cm) were calendered with a linear pressure of 9 N/mm and then transferred to a glovebox (argon atmosphere, water content <1 ppm, oxygen content <10 ppm). Before building the cell, the electrodes were dried once again at 5 mbar and 120° C. overnight). For the building of the electrochemical test cells (2-electrode test arrangement analogous to a button cell), circular pieces with a diameter of 20 mm were punched out. A glass fiber separator (Whatman GF/D, thickness 630 μm) was used, and lithium foil was used as the counter electrode. The electrolyte used was 1 M LiPF₆ in a 1:1 mixture of ethylene carbonate and ethyl methyl carbonate. For electrochemical characterization, the cells were connected to a Maccor Series 4000 battery cycling tester. The cells were cycled at a specific current of 30 mA per gram of active material between 10 mV and 2 V against Li/Li⁺. After reaching 10 mV, the voltage was kept constant for 30 min.

### EXAMPLE 30

### Characterization of AM5 from Example 18

The active material AM5 obtained in example 18 was subsequently blended with conductive black (Super P Li, Timcal) and binder (polyvinylidene fluoride, Kynarflex 2801) in order to obtain a viscous coating composition consisting of 86% by weight of the active material obtained in example 18, 5.8% by weight of conductive black and 8.2% by weight of binder in N-ethyl-2-pyrrolidone (NEP) solvent. The amount of solvent used was 125% by weight of the solids content used. For better homogenization, the coating composition was stirred by means of a magnetic stirrer for 16 hours. The coating composition was then applied by means of a film applicator (Erichsen Coatmaster 509 MC) to a 20 μm-thick Cu foil (purity 99.9%) in a coating bar process, and promptly introduced into a drying cabinet. Drying took place at 120° C. under reduced pressure overnight. After drying, the resulting electrodes (width 8 cm) were calendered with a linear pressure of 9 N/mm and then transferred to a glovebox (argon atmosphere, water content <1 ppm, oxygen content <10 ppm). Before building the cell, the electrodes were dried once again at 5 mbar and 120° C. overnight). For the building of the electrochemical test cells (2-electrode test arrangement analogous to a button cell), circular pieces with a diameter of 20 mm were punched out. A glass fiber separator (Whatman GF/D, thickness 630 μm) was used, and lithium foil was used as the counter electrode. The electrolyte used was 1 M LiPF₆ in a 1:1 mixture of ethylene carbonate and ethyl methyl carbonate. For electrochemical characterization, the cells were connected to a Maccor Series 4000 battery cycling tester. The cells were cycled at a specific current of 30 mA per gram of active material between 10 mV and 2 V against Li/Li⁺. After reaching 10 mV, the voltage was kept constant for 30 min.

### EXAMPLE 31

### Characterization of AM6 from Example 21

The active material AM6 obtained in example 21 was subsequently blended with conductive black (Super P Li, Timcal) and binder (polyvinylidene fluoride, Kynarflex 2801) in order to obtain a viscous coating composition consisting of 84.3% by weight of the active material obtained in example 21, 6.7% by weight of conductive black and 9% by weight of binder in N-ethyl-2-pyrrolidone (NEP) solvent. The amount of solvent used was 125% by weight of the solids content used. For better homogenization, the coating composition was stirred by means of a magnetic stirrer for 16 hours. The coating composition was then applied by means of a film applicator (Erichsen Coatmaster 509 MC) to a 20 μm-thick Cu foil (purity 99.9%) in a coating bar process, and promptly introduced into a drying cabinet. Drying took place at 120° C. under reduced pressure overnight. After drying, the resulting electrodes (width 8 cm) were calendered with a linear pressure of 9 N/mm and then transferred to a glovebox (argon atmosphere, water content <1 ppm, oxygen content <10 ppm). Before building the cell, the electrodes were dried once again at 5 mbar and 120° C. overnight). For the building of the electrochemical test cells (2-electrode test arrangement analogous to a button cell), circular pieces with a diameter of 20 mm were punched out. A glass fiber separator (Whatman GF/D, thickness 630 μm) was used, and lithium foil was used as the counter electrode. The electrolyte used was 1 M LiPF₆ in a 1:1 mixture of ethylene carbonate and ethyl methyl carbonate. For electrochemical characterization, the cells were connected to a Maccor Series 4000 battery cycling tester. The cells were cycled at a specific current of 30 mA per gram of active material between 10 mV and 2 V against Li/Li⁺. After reaching 10 mV, the voltage was kept constant for 30 min.

### EXAMPLE 32

### Characterization of AM7 from Example 23

The active material AM7 obtained in example 23 was subsequently blended with conductive black (Super P Li, Timcal) and binder (polyvinylidene fluoride, Kynarflex 2801) in order to obtain a viscous coating composition consisting of 86.2% by weight of the active material obtained in example 23, 6% by weight of conductive black and 7.8% by weight of binder in N-ethyl-2-pyrrolidone (NEP) solvent. The amount of solvent used was 125% by weight of the solids content used. For better homogenization, the coating composition was stirred by means of a magnetic stirrer for 16 hours. The coating composition was then applied by means of a film applicator (Erichsen Coatmaster 509 MC) to a 20 μm-thick Cu foil (purity 99.9%) in a coating bar process, and promptly introduced into a drying cabinet. Drying took place at 120° C. under reduced pressure overnight. After drying, the resulting electrodes (width 8 cm) were calendered with a linear pressure of 9 N/mm and then transferred to a glovebox (argon atmosphere, water content <1 ppm, oxygen content <10 ppm). Before building the cell, the electrodes were dried once again at 5 mbar and 120° C. overnight). For the building of the electrochemical test cells (2-electrode test arrangement analogous to a button cell), circular pieces with a diameter of 20 mm were punched out. A glass fiber separator (Whatman GF/D, thickness 630 μm) was used, and lithium foil was used as the counter electrode. The electrolyte used was 1 M LiPF₆ in a 1:1 mixture of ethylene carbonate and ethyl methyl carbonate. For electrochemical characterization, the cells were connected to a Maccor Series 4000 battery cycling tester. The cells were cycled at a specific current of 30 mA per gram of active material between 10 mV and 2 V against Li/Li⁺. After reaching 10 mV, the voltage was kept constant for 30 min.

### EXAMPLE 33

### Characterization of AM8 from Example 25

The active material AM8 obtained in example 25 was subsequently blended with conductive black (Super P Li, Timcal) and binder (polyvinylidene fluoride, Kynarflex 2801) in order to obtain a viscous coating composition consisting of 87.6% by weight of the active material obtained in example 25, 4.8% by weight of conductive black and 7.6% by weight of binder in N-ethyl-2-pyrrolidone (NEP) solvent. The amount of solvent used was 125% by weight of the solids content used. For better homogenization, the coating composition was stirred by means of a magnetic stirrer for 16 hours. The coating composition was then applied by means of a film applicator (Erichsen Coatmaster 509 MC) to a 20 μm-thick Cu foil (purity 99.9%) in a coating bar process, and promptly introduced into a drying cabinet. Drying took place at 120° C. under reduced pressure overnight. After drying, the resulting electrodes (width 8 cm) were calendered with a linear pressure of 9 N/mm and then transferred to a glovebox (argon atmosphere, water content <1 ppm, oxygen content <10 ppm). Before building the cell, the electrodes were dried once again at 5 mbar and 120° C. overnight). For the building of the electrochemical test cells (2-electrode test arrangement analogous to a button cell), circular pieces with a diameter of 20 mm were punched out. A glass fiber separator (Whatman GF/D, thickness 630 μm) was used, and lithium foil was used as the counter electrode. The electrolyte used was 1 M LiPF₆ in a 1:1 mixture of ethylene carbonate and ethyl methyl carbonate. For electrochemical characterization, the cells were connected to a Maccor Series 4000 battery cycling tester. The cells were cycled at a specific current of 30 mA per gram of active material between 10 mV and 2 V against Li/Li⁺. After reaching 10 mV, the voltage was kept constant for 30 min.

### DESCRIPTION OF THE FIGURES

FIG. 1 shows the discharge capacity (in mAh/g on the y axis) for the 4 active materials AM1, AM2, AM3 and AM4 from examples 10, 12, 14 and 16. The capacity achieved is initially above values achievable for graphite, but a decline in the capacity can be detected thereafter. However, differences between the materials are detectable: while a rapid (continuous) decline to capacity values characteristic of the carbon present in proportions in the materials occurs in the case of materials AM1 and AM2, the decline in capacity is attenuated in the case of materials AM3 and particularly AM4.

FIGS. 2a to 2d show the plot of differential capacity (in Ah/V on the y axis) against the voltage (in V on the x axis). The values shown were calculated from the measured data from a chronoamperometry measurement. In chronoamperometry, a constant current is defined, and the changes in the voltage are registered. The plot of the resulting differential capacity against voltage allows statements to be made about characteristic electrochemical processes, for example incorporation or discharge of lithium, or decomposition of electrolyte. The characteristic peaks for electrochemical activity of tin at 0.4 V (incorporation or formation of alloy of lithium with tin, negative y axis) and between 0.6 and 0.8 volt (3 peaks for lithium extraction from lithium-tin alloy, positive y axis) are clearly evident.

FIG. 2a shows the differential capacity against voltage for material AM1 from example 10. The first cycle is shown as a solid line and the tenth cycle as a broken line. The severe decline in the electrochemical activity of tin is clearly evident.

FIG. 2b shows the differential capacity against voltage for material AM2 from example 12. The first cycle is shown as a solid line and the tenth cycle as a broken line. The severe decline in the electrochemical activity of tin is clearly evident.

FIG. 2c shows the differential capacity against voltage for material AM3 from example 14. The first cycle is shown as a solid line and the tenth cycle as a broken line. The severe decline in the electrochemical activity of tin is clearly evident.

FIG. 2d shows the differential capacity against voltage for material AM4 from example 16. The first cycle is shown as a solid line and the tenth cycle as a broken line. A decline in the electrochemical activity of tin is evident. This is less severe than in the case of materials AM1, AM2 and AM3.

FIG. 3 shows the discharge capacity (in mAh/g on the y axis) for the 3 active materials AM5, AM6 and AM7 from examples 18, 21 and 23 over 25 cycles (number of cycles on the x axis). The capacity achieved is initially above values achievable for graphite for materials AM6 and AM7, while material AM5 is significantly lower. The differences are attributable to different Co—Sn compounds having different electrochemical activities. In AM6 and AM7, predominantly the CoSn2 phase is present, whereas the material AM5 is present in the CoSn composition. The capacity declines only slightly over the first 25 cycles, which is a distinct improvement over the materials without stabilizing cobalt (AM1, AM2, AM3, AM4).

FIGS. 4a to 4c show the plot of differential capacity (in Ah/V on the y axis) against the voltage (in V on the x axis). The values shown were calculated from the measured data from a chronoamperometry measurement. In chronoamperometry, a constant current is defined, and the changes in the voltage are registered. The plot of the resulting differential capacity against voltage allows statements to be made about characteristic electrochemical processes, for example incorporation or discharge of lithium, or decomposition of electrolyte. The characteristic peaks for electrochemical activity of tin at 0.4 V (incorporation or formation of alloy of lithium with tin, negative y axis) and between 0.6 and 0.8 volt (3 peaks for lithium extraction from lithium-tin alloy, positive y axis) are clearly evident.

FIG. 4a shows the differential capacity against voltage for material AM5 from example 18. The first cycle is shown as a solid line and the tenth cycle as a broken line. The high Co content leads to formation of the CoSn phase. Only minimal electrochemical activity of Sn is evident; the main proportion of the capacity is attributable to lithium incorporation into carbon.

FIG. 4b shows the differential capacity against voltage for material AM6 from example 21. The first cycle is shown as a solid line and the tenth cycle as a broken line. Sn is present predominantly in CoSn₂, and exhibits nearly constantly high electrochemical activity.

FIG. 4c shows the differential capacity against voltage for material AM7 from example 23. The first cycle is shown as a solid line and the tenth cycle as a broken line. Sn exhibits nearly constantly high electrochemical activity; the contribution of carbon is minor.

FIG. 5 shows the discharge capacity (in mAh/g on the y axis) for two cells of material AM8 from example 25 over 30 cycles (number of cycles on the x axis). The capacity achieved is below values achievable for graphite, and later exhibits a moderate decline. On the basis of the homogeneous measurement points, high reproducibility is evident.

FIG. 6 shows the plot of differential capacity (in Ah/V on the y axis) against the voltage (in V on the x axis) for material AM8 from example 25. The first cycle is shown as a solid line and the tenth cycle as a broken line. The values shown were calculated from the measured data from a chronoamperometry measurement. In chronoamperometry, a constant current is defined, and the changes in the voltage are registered. The plot of the resulting differential capacity against voltage allows statements to be made about characteristic electrochemical processes, for example incorporation or discharge of lithium, or decomposition of electrolyte. The characteristic peaks for electrochemical activity of tin at 0.4 V (incorporation or formation of alloy of lithium with tin, negative y axis) and between 0.6 and 0.8 volt (3 peaks for lithium extraction from lithium-tin alloy, positive y axis) are clearly evident. In the course of cycling, the peak height, width and position change, which indicates alterations within the material.

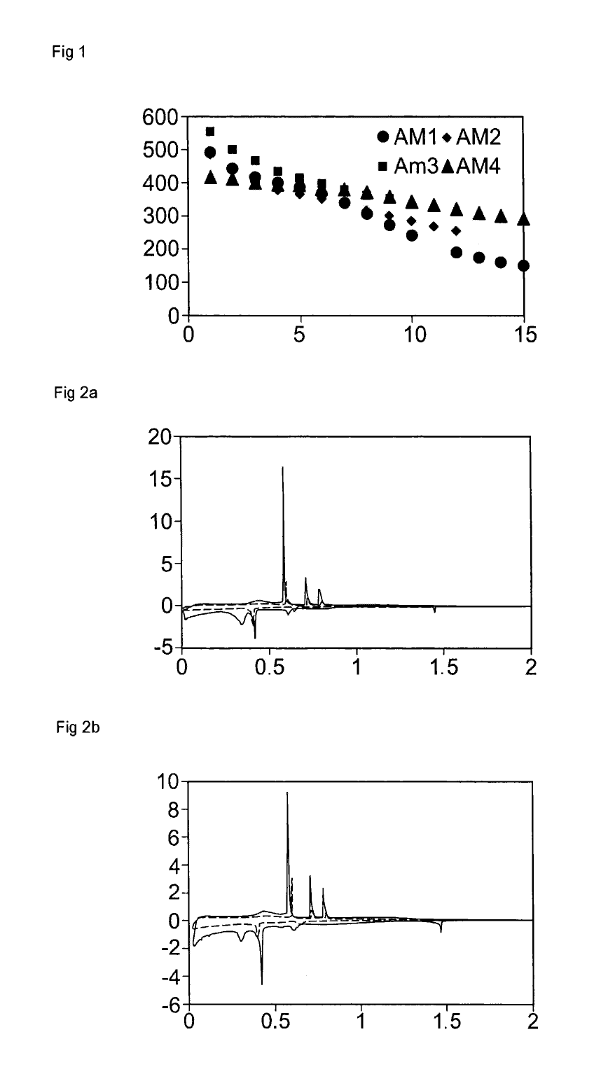

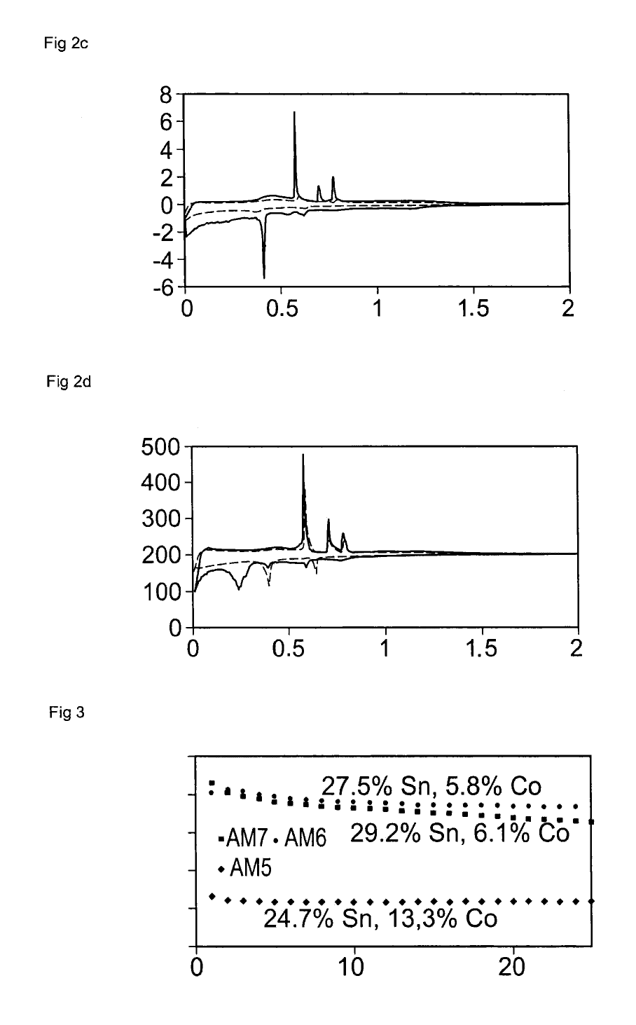

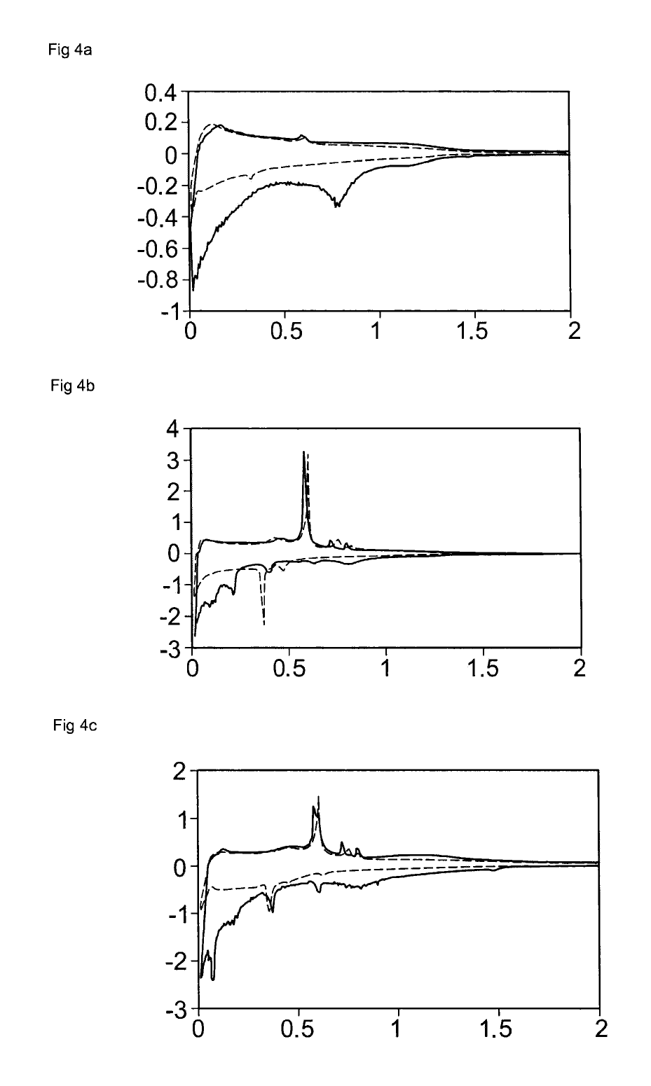

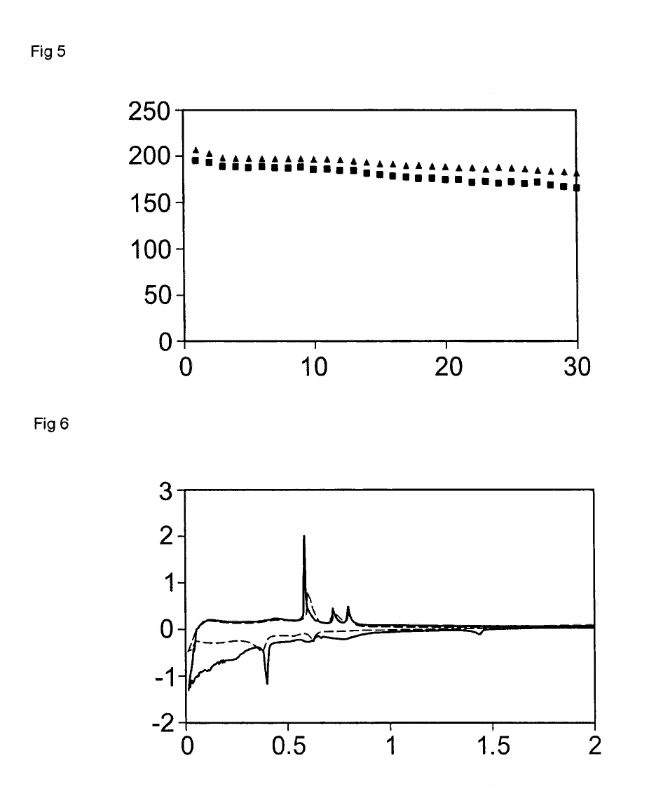

1. A process for producing an Sn(II)-crosslinked novolac material, comprising the process steps of:
(a) reacting at least one novolac comprising aryl units which bear two, three or four hydroxyl groups, with at least two hydroxyl groups adjacent to one another, and which are joined to further aryl units via at least one substituted or unsubstituted alkylene group, with at least one Sn(II) salt, and
(b) optionally isolating the Sn(II)-crosslinked novolac material formed in the form of a powder.

2. The process according to claim 1, wherein process step (a) is performed in a solvent in which the novolac is present in dissolved form.

3. The process according to claim 2, wherein the solvent used is water, a C₁-C₆-alkanol or a cyclic or acyclic ether having 4 to 8 carbon atoms.

4. The process according to any of claims 1 to 3, wherein process step (a) is performed in the presence of a base.

5. The process according to any of claims 1 to 4, wherein the alkylene groups present in the novolac are methylene units which each join two aryl units to one another.

6. The process according to any of claims 1 to 5, wherein the novolac has an average of 2 to 10 aryl units.

7. The process according to any of claims 1 to 6, wherein at least 50% of the aryl units of the novolac bear two hydroxyl groups which are adjacent, and at least 50% of the alkylene units are methylene groups.

8. The process according to any of claims 1 to 7, wherein the Sn(II) salt is selected from the group of salts consisting of SnCl₂, SnBr₂, Sn(acetate)₂, SnSO₄, Sn(NO₃)₂ and mixtures of these salts and hydrates thereof.

9. The process according to any of claims 1 to 8, wherein the molar ratio of the Sn(II) salt to the aryl units from the novolac which bear two, three or four hydroxyl groups, with at least two hydroxyl groups adjacent to one another, is from 0.1:1 to 1:1.

10. An Sn(II) crosslinked novolac material obtainable by reacting a novolac comprising aryl units which bear two, three or four hydroxyl groups, with at least two hydroxyl groups adjacent to one another, and which are joined to further aryl units via at least one substituted or unsubstituted alkylene group, with at least one Sn(II) salt.

11. A process for producing an electroactive material comprising
i) a carbon phase C;
ii) at least one SnOₓ phase in which x is a number from 0 to 2;
the carbon phase C and the SnOₓ phase forming essentially co-continuous phase domains, the mean distance between two adjacent domains of identical phases being not more than 10 nm, or the SnOx phase where x is less than 0.2 being in the form of SnOₓ domains embedded essentially in isolation in a continuous carbon phase C as a matrix, in which more than 50% of the SnOₓ domains have a size in the range from 1 nm to 20 μm, comprising the process steps of
(a) reacting at least one novolac comprising aryl units which bear two, three or four hydroxyl groups, with at least two hydroxyl groups adjacent to one another, and which are joined to further aryl units via at least one substituted or unsubstituted alkylene group, with at least one Sn(II) salt to give an Sn(II)-crosslinked novolac material,
(b) optionally isolating the Sn(II)-crosslinked novolac material formed in the form of a powder, and
(c) carbonizing the Sn(II)-crosslinked novolac material and optionally partially or fully reducing Sn(II) to Sn(0).

12. The process according to claim 11, wherein the process for producing the Sn(II)-crosslinked novolac material is performed according to any of claims 2 to 9.

13. The process according to claim 11 or 12, wherein the carbonization of the Sn(II)-crosslinked novolac material in process step (c) is performed in one or more stages with substantial or complete exclusion of oxygen.

14. The process according to any of claims 11 to 13, wherein the carbonization of the Sn(II)-crosslinked novolac material in process step (c) is performed in the presence of a protective or reactive gas selected from Ar, N₂, H₂, NH₃, CO and C₂H₂, and mixtures thereof.

15. The process according to claim 13 or 14, wherein the partial or full reduction of Sn(II) to Sn(0) in process step (c) is performed in the presence of a reactive gas selected from H₂, NH₃, CO and C₂H₂, and mixtures thereof.

16. An electroactive material obtainable by a process according to any of claims 11 to 15.

17. An electroactive material comprising
i) a carbon phase C;
ii) at least one SnOₓ phase in which x is a number from 0 to 2;
the carbon phase C and the SnOₓ phase forming essentially co-continuous phase domains, the mean distance between two adjacent domains of identical phases being not more than 10 nm, or the SnOₓ phase where x is less than 0.2 being in the form of SnOₓ domains embedded essentially in isolation in a continuous carbon phase C as a matrix, in which more than 50% of the SnOₓ domains have a size in the range from 1 nm to 20 μm, wherein the tin content in the electroactive material is 5 to 90% based on the total mass of the electroactive material.

18. The electroactive material according to claim 16 or 17, wherein the number x of the SnOₓ phase of the electroactive material is a number less than 0.2.

19. The use of the electroactive material according to any of claims 16 to 18 as a constituent of an electrode for an electrochemical cell.

20. An electrode for an electrochemical cell comprising electroactive material according to any of claims 16 to 18.

21. An electrochemical cell comprising at least one electrode according to claim 20.

22. The use of electrochemical cells according to claim 21 in lithium ion batteries.

23. A lithium ion battery comprising at least one electrochemical cell according to claim 21.

24. The use of electrochemical cells according to claim 21 in automobiles, bicycles driven by electric motor, aircraft, ships or stationary energy stores.
